(19) United States
(12) Patent Application Publication
(10) Pub. No.: US 2011/0128741 A1
(43) Pub. Date: Jun. 2, 2011

(54) LIGHTING APPARATUS

(75) Inventor: Wen-Kuei Tsai, Taipei City (TW)

(73) Assignee: GE INVESTMENT CO., LTD., Taipei City (TW)

(21) Appl. No.: 12/882,668

(22) Filed: Sep. 15, 2010

Related U.S. Application Data
(60) Provisional application No. 61/264,841, filed on Nov. 30, 2009.

(51) Int. Cl. F21V 21/30

(52) U.S. Cl. 362/287

(57) ABSTRACT

A lighting apparatus including a stationary support, a lighting body, a transparent cover, and a self-cleaning layer is provided. The lighting body pivotally connects to the stationary support and includes a holder and a light-emitting diode module. The holder has a first portion and a second portion. The light-emitting diode module is installed in the first portion of the holder. The transparent cover is located between the first portion and the second portion and covers the light-emitting diode module. The self-cleaning layer covers the surface of the transparent cover to filter UV light from the environment.

### BACKGROUND OF THE INVENTION

1. Field of the Invention

The present invention generally relates to a lighting apparatus, and more particularly, to a lighting apparatus with high reliability and safety and low maintaining cost.

2. Description of Related Art

Generally, outdoor lighting apparatuses used to illuminate buildings or objects require to be periodically cleaned due to accumulation of dust. A conventional lighting apparatus typically includes a stationary support, a lighting body pivotally connected to the stationary support, a cover glass assembled with the lighting body, and a waterproof rubber disposed between the cover glass and the lighting body. The above-mentioned lighting body typically includes a lamp holder and a fluorescent lamp installed within the lamp holder and covered by the cover glass.

When the conventional lighting apparatus is installed outdoor, IR light or UV light emitted from the fluorescent lamp and from outdoor environment may damage the waterproof rubber, and thus the lifetime of the lighting apparatus is significantly reduced. In addition, the cover glass of the lighting apparatus is heavy, fragile, dangerous, and expensive. Moreover, it requires to be cleaned on a regular time schedule due to accumulation of dust. Maintenance of the cover glass costs much money.

### SUMMARY OF THE INVENTION

Accordingly, the present invention is directed to a lighting apparatus with high safety and reliability as well as the manufacturing cost and maintaining cost of which can be decreased.

The present invention provides a lighting apparatus that comprises: a stationary support; a lighting body pivotally connected to the stationary support, the light body comprising a holder having a first portion, a second portion, and a light-emitting diode module installed in the first portion; a transparent cover assembled with the lighting body, wherein the transparent cover is located between the first portion and the second portion and covers the light-emitting diode module; and a self-cleaning layer covering an outer surface of the transparent cover to filter UV light from the environment.

In an embodiment, the lighting apparatus further comprises a waterproof rubber that is located between the second portion and the first portion of the holder and covers an outer edge of the transparent cover.

In an embodiment, the transparent cover is a mat light-transmissive lens allowing a portion of light emitted by the light-emitting diode module to pass through the transparent cover.

In an embodiment, the transparent cover is a transparent glass lens transmitting substantially whole light emitted by the light-emitting diode module to pass through the transparent cover.

In an embodiment, wherein the transparent cover is made of polycarbonate or acrylic resin.

In an embodiment, the second portion of the holder comprises a plurality of conduit grooves disposed on an outer surface of the second portion.

In an embodiment, each of the conduit grooves has an inclined plane extending downward from the inner edge of the second portion downward to the outer edge of the second portion.

In an embodiment, the self-cleaning layer comprises a TiO₂ film.

In an embodiment, the light-emitting diode module comprises a carrier, and a plurality of light-emitting diodes disposed on the carrier and electrically connected to the carrier.

In an embodiment, the lighting apparatus further comprises a plurality of fasten members, a plurality of through holes arranged in the second portion, and a plurality of positioning holes arranged in the first portion, where the through holes of the second portion respectively correspond to the positioning holes of the first portion, and the fasten members sequentially go through the through holes of the second portion and the positioning holes of the first portion so as to fasten the second portion on the first portion.

In an embodiment, the fasten members comprise screw or bolt.

In an embodiment, the diameter of the transparent cover is smaller than the diameter of the first portion or the diameter of the second portion.

Based on the depiction above, the present invention provides lighting apparatus in which the LED module is installed so that no IR light or UV light is emitted from the LED module, and thus the waterproof rubber installed within the lighting apparatus will not be damaged by the IR light or UV light. In addition, the self-cleaning layer covered on the transparent cover not only has self-clean function such that neither periodical cleans nor occasional cleans for the transparent cover are needed, but also has disinfection function to destroy disease germs, and further has filtration function to filter UV light from the environment. In addition, because the transparent cover can be made of polycarbonate or acrylic resin, the lighting apparatus of the present invention effectively reduces the production cost and has relatively high safety in comparison with prior art.

It is to be understood that both the foregoing general descriptions and the detailed embodiments are exemplary and are, together with the accompanying drawings, intended to provide further explanation of technical features and advantages of the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a lighting apparatus according to an embodiment of the present invention.

FIG. 2 is a partially exploded view of the lighting apparatus of FIG. 1.

FIG. 3 is a schematic cross-sectional view showing relative positions of the transparent cover, the self-cleaning layer and the waterproof rubber of the lighting apparatus depicted in FIG. 1.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

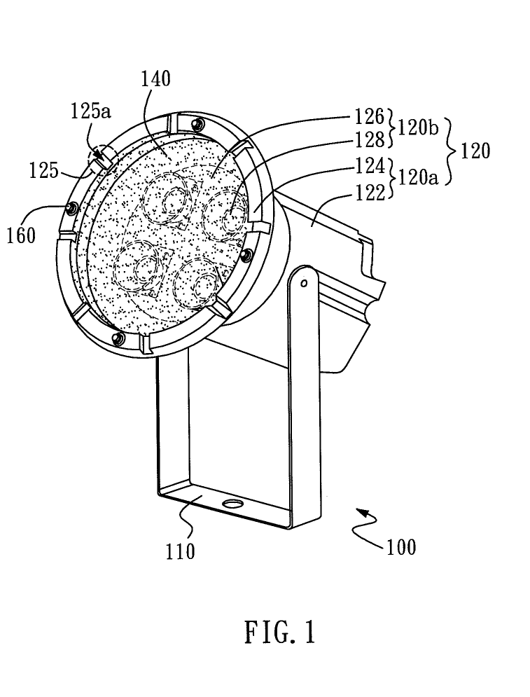

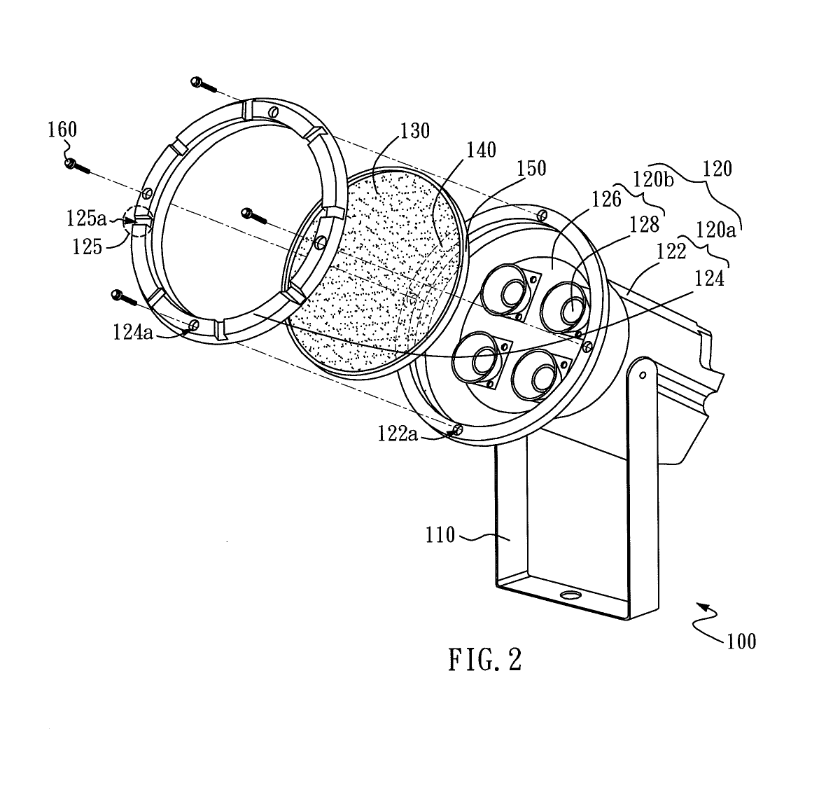

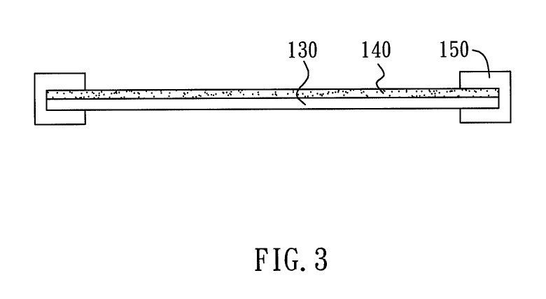

FIG. 1 is a diagram of a lighting apparatus according to an embodiment of the present invention. FIG. 2 is a partially exploded view of the lighting apparatus of FIG. 1. FIG. 3 is a schematic cross-sectional view showing relative positions of the transparent cover, the self-cleaning layer, and the waterproof rubber of the lighting apparatus depicted in FIG. 1.

Referring to FIGS. 1 and 2, the present embodiment provides a lighting apparatus 100 that comprises a stationary support 110, a lighting body 120, a transparent cover 130, and a self-cleaning layer 140. The lighting apparatus 100 of the present embodiment is suitable to function as street lightings or projecting lightings.

Specifically, the lighting body 120 is pivotally connected to the stationary support 110, and the lighting body 120 includes a holder 120a and a light-emitting diode (LED) module 120b. Moreover, the holder 120a has a first portion 122 and a second portion 124. The LED module 120b is installed within the first portion 122 of the holder 120a. The LED module 120b of the present embodiment may be a chip on board (COB) type package or other types of packages, such as a lead-frame type package. Taking the COB type package as an example, the LED module 120b includes a carrier 126 and a plurality of LEDs 128. The LEDs 128 are electrically connected with the carrier 126 and arranged on the carrier 126 in an array pattern or other patterns. In embodiment of FIGS. 1 and 2, the carrier 126 is a circuit board, but it should not be limited. In addition, The LEDs 128 may be connected with the carrier 126 by surface mounted device (SMD), pin through hole (PTH), or other suitable packaging technologies.

Referring to FIGS. 1, 2 and 3, the transparent cover 130 is assembled with the lighting body 120. In detail, the transparent cover 130 covers the LED module 120b and is located between the first portion 122 and the second portion 124. Herein, the transparent cover 130 is made of, for example, polycarbonate, acrylic resin, or other suitable materials. In another embodiment, the transparent cover 130 is a lens for transmitting light, such as a mat light-transmissive lens, which allows a portion of light emitted by the LEDs 128 to pass through the transparent cover 130, or a transparent glass lens, which transmits the substantially whole light emitted by the LEDs 128 through the transparent cover 130.

Referring to FIG. 3, the self-cleaning layer 140 covers an outer surface of the transparent cover 130 to filter UV light from the environment. In the present embodiment, the self-cleaning layer 140 is, for example, a TiO₂ film. The diameter of the transparent cover 130 of the present embodiment may be smaller than the diameter of the first portion 122 or the second portion 124 of the holder 120a. Methods for forming the self-cleaning layer 140 may comprise spin coating, ink-jetting, dip coating, or other suitable methods.

In the present embodiment, because the self-cleaning layer 140 covered on the transparent cover 130 has self-clean function, neither periodically cleans nor occasionally cleans for the transparent cover 130 are needed. In addition, because the transparent cover 130 can be made of polycarbonate or acrylic resin, the lighting apparatus 100 of the present invention effectively reduces the production cost and has relatively high safety in comparison with prior art.

Furthermore, referring to FIGS. 1 and 3, the lighting apparatus 100 further comprises a waterproof rubber 150. Herein, the waterproof rubber 150 covers an outer edge of the transparent cover 130, and the waterproof rubber 150 is located between the second portion 124 and the first portion 122 of the holder 120a.

Since the waterproof rubber 150 covers the outer edge of the transparent cover 130 for achieving a waterproof effect, the electronic elements inside the first portion 122 of the holder 120a such as LEDs 128 and the carrier 126 are prevented from being damaged by moisture, and the performance and reliability of the lighting apparatus 100 can be ensured.

Moreover, referring to the FIGS. 1 and 2, in the lighting apparatus 100 of the present embodiment, the second portion 124 of the holder 120a includes a plurality of conduit grooves 125 disposed on an outer surface of the second portion 124. Herein, the outer surface of the second portion 124 is opposite to the inner surface of the second portion 124, and the inner surface of the second portion 124 faces to the LEDs 128 disposed inside the first portion 122 of the holder 120a.

Specially, each of the conduit grooves 125 in the embodiment has an inclined plane 125a, wherein the inclined plane 125a extends downward from the inner edge of the second portion 124 to the outer edge of the second portion 124. In other words, the inclined plane 125a has two ends; the height of one end adjacent to the transparent cover 130 is higher than the height of the other end far way from the transparent cover 130. The inclined plane 125 of the conduit grooves 125 is employed for improving water drainage when the lighting apparatus 100 is used outdoors.

Referring to FIGS. 1 and 2, the lighting apparatus 100 of the present embodiment further includes a plurality of fasten members 160, a plurality of through holes 124a arranged in the second portion 124 of the holder 120a, and a plurality of positioning holes 122a arranged in the first portion 122 of the holder 120a. Wherein the through holes 124a of the second portion 124 respectively correspond to the positioning holes 122a of the first portion 122, and the fasten members 160 sequentially go through the through holes 124a of the second portion 124 and the positioning holes 122a of the first portion 122 so as to fasten the second portion 124 on the first portion 122. Herein, the fasten members 160 in the present embodiment comprises screws or bolts, but it should not be limited.

Notice that the present invention does not limit the configuration of the fasten members 160, the through holes 124a, and the positioning holes 122. Other structures capable of having the same fixing effect are still fallen in the technical scheme adopted by the present invention without departing from the scope of the invention.

Based on the depiction above, the present invention provides lighting apparatus in which the LED module is installed so that no IR light or UV light is emitted from the LED module, and thus the waterproof rubber installed within the lighting apparatus will not be damaged by the IR light or UV light.

In addition, the self-cleaning layer covered on the transparent cover not only has self-clean function such that neither periodical cleans nor occasional cleans for the transparent cover are needed, but also has disinfection function to destroy disease germs, and further has filtration function to filter UV light from the environment. In addition, because the transparent cover can be made of polycarbonate or acrylic resin, the lighting apparatus of the present invention effectively reduces the production cost and has relatively high safety in comparison with prior art.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A lighting apparatus, comprising:
a stationary support;
a lighting body pivotally connected to the stationary support, the light body comprising a holder having a first portion, a second portion, and a light-emitting diode module installed in the first portion;
a transparent cover assembled with the lighting body, wherein the transparent cover is located between the first portion and the second portion and covers the light-emitting diode module; and
a self-cleaning layer covering an outer surface of the transparent cover to filter UV light from the environment.

2. The lighting apparatus as claimed in claim 1, further comprising a waterproof rubber that is located between the second portion and the first portion of the holder and covers an outer edge of the transparent cover.

3. The lighting apparatus as claimed in claim 1, wherein the transparent cover is a mat light-transmissive lens allowing a portion of light emitted by the light-emitting diode module to pass through the transparent cover.

4. The lighting apparatus as claimed in claim 1, wherein the transparent cover is a transparent glass lens transmitting substantially whole light emitted by the light-emitting diode module to pass through the transparent cover.

5. The lighting apparatus as claimed in claim 1, wherein the transparent cover is made of polycarbonate or acrylic resin.

6. The lighting apparatus as claimed in claim 1, wherein the second portion of the holder comprises a plurality of conduit grooves disposed on an outer surface of the second portion.

7. The lighting apparatus as claimed in claim 6, wherein each of the conduit grooves has an inclined plane extending downward from the inner edge of the second portion downward to the outer edge of the second portion.

8. The lighting apparatus as claimed in claim 1, wherein the self-cleaning layer comprises a TiO₂ film.

9. The lighting apparatus as claimed in claim 1, wherein the light-emitting diode module comprises:
a carrier; and
a plurality of light-emitting diodes, disposed on the carrier and electrically connected to the carrier.

10. The lighting apparatus as claimed in claim 1, further comprises a plurality of fasten members, a plurality of through holes arranged in the second portion, and a plurality of positioning holes arranged in the first portion, wherein the through holes of the second portion respectively correspond to the positioning holes of the first portion, and the fasten members sequentially go through the through holes of the second portion and the positioning holes of the first portion so as to fasten the second portion on the first portion.

11. The lighting apparatus as claimed in claim 10, wherein the fasten members comprise screw or bolt.

12. The lighting apparatus as claimed in claim 1, wherein the diameter of the transparent cover is smaller than the diameter of the first portion or the diameter of the second portion.
